(19) United States
(12) Patent Application Publication
(10) Pub. No.: US 2025/0242291 A1
(43) Pub. Date: Jul. 31, 2025

(54) CARBON DIOXIDE RECOVERY DEVICE

(71) Applicant: HONDA MOTOR CO., LTD., Tokyo (JP)

(72) Inventors: Toshiyuki INABA, Saitama (JP); Hiroka SHIGI, Saitama (JP); Masanobu TAKAZAWA, Saitama (JP)

(21) Appl. No.: 19/033,496

(22) Filed: Jan. 22, 2025

(30) Foreign Application Priority Data
Jan. 25, 2024 (JP) 2024-009357

(51) Int. Cl. B01D 53/04

(52) U.S. Cl. CPC B01D 53/0454; B01D 53/0438; B01D 53/0446; B01D 2257/504

(57) ABSTRACT

A carbon dioxide recovery device includes: a module that includes a sorbent material inside thereof, and executes an adsorption process of aspirating a gas containing carbon dioxide and adsorbing the carbon dioxide to the sorbent material; and a desorption process of desorbing the carbon dioxide from the sorbent material by heating in a state where a periphery of the sorbent material is reduced pressure; a first carbon dioxide tank that stores the carbon dioxide recovered from the module; an oxidation inhibiting gas tank (second carbon dioxide tank, inert gas tank) that stores an oxidation inhibiting gas that prevents oxidation of the sorbent material; and a controller that supplies the oxidation inhibiting gas from the oxidation inhibiting gas tank to the module during execution of the desorption process, when an emergency situation is detected.

This application is based on and claims the benefit of priority from Japanese Patent Application No. 2024-009357, filed on 25 Jan. 2024, the content of which is incorporated herein by reference.

### BACKGROUND OF THE INVENTION

### Field of the Invention

The present invention relates to a carbon dioxide recovery device.

### Related Art

Conventionally, technology for recovering predetermined components from atmospheric air, exhaust gas, etc. has been known. As a document disclosing this type of technology, Japanese Unexamined Patent Application, Publication No. H11-226353 can be exemplified.

Japanese Unexamined Patent Application, Publication No. H11-226353 relates to exhaust gas treatment equipment which removes ash in exhaust gas discharged from a trash treatment plant, and removes dioxins by adding activated carbon into the exhaust gas. Japanese Unexamined Patent Application, Publication No. H11-226353 describes blowing an inert gas to powdered adsorbent-containing dust ash exhausted from a dust collector to suppress oxidative heat generation of a powdered adsorbent.

Patent Document 1: Japanese Unexamined Patent Application, Publication No. H11-226353

### SUMMARY OF THE INVENTION

However, the carbon dioxide recovery device performs the recovery of carbon dioxide by causing a module retaining a sorbent material to execute an adsorption process of aspirating a gas such as air containing carbon dioxide and adsorbing to the sorbent material, and a desorption process of desorbing the adsorbed carbon dioxide by reducing the pressure and heating the sorbent material.

The sorbent material oxidizes if exposed to atmospheric air in a high-temperature state, and the adsorption performance declines. Although valve are controlled so that the sorbent material is isolated from atmospheric air in the desorption process during normal running, there is concern over a valve opening and the isolation of the sorbent material from atmospheric air being released during power outage or failure. Since it reaches a high-temperature state in the desorption process, if atmospheric air penetrates to inside of the module, the sorbent material will deteriorate.

The present invention has an object of providing a carbon dioxide recovery device which can suppress degradation of sorbent material caused by oxidation, even if isolation of the sorbent material from atmospheric air is released during emergency.

A first aspect of the present invention relates to a carbon dioxide recovery device (for example, the carbon dioxide recovery device 1, 1a described later) including: a module (for example, the module 11 described later) that includes a sorbent material (for example, the sorbent material 12 described later) inside thereof, and executes an adsorption process of aspirating a gas containing carbon dioxide and adsorbing the carbon dioxide to the sorbent material, and a desorption process of desorbing the carbon dioxide from the sorbent material by heating in a state where a periphery of the sorbent material is reduced pressure; a carbon dioxide tank (for example, the first carbon dioxide tank 66 described later) that stores the carbon dioxide recovered from the module in a course of the adsorption process and the desorption process; an oxidation inhibiting gas tank (for example, the second carbon dioxide tank 68 and inert gas tank 69 described later) that stores an oxidation inhibiting gas that prevents oxidation of the sorbent material; and a controller (for example, the controller 90 described later) that supplies the oxidation inhibiting gas from the oxidation inhibiting gas tank to the module during execution of the desorption process, when an emergency situation is detected.

According to a second aspect of the present invention, in the carbon dioxide recovery device as described in the first aspect, the oxidation inhibiting gas tank may be an inert gas tank that stores an inert gas as the oxidation inhibiting gas.

According to a third aspect of the present invention, in the carbon dioxide recovery device as described in the first aspect, the oxidation inhibiting gas tank may be a second carbon dioxide tank that stores the carbon dioxide recovered from the module as the oxidation inhibiting gas.

According to a fourth aspect of the present invention, in the carbon dioxide recovery device as described in any one of the first to third aspects, the oxidation inhibiting gas tank stores the oxidation inhibiting gas at a fixed pressure or more.

According to a fifth aspect of the present invention, in the carbon dioxide recovery device as described in any one of the first to third aspects, the controller stops supply of the oxidation inhibiting gas, when an internal pressure of the module undergoing supply of the oxidation inhibiting gas becomes a fixed value or more.

According to the present invention, it is possible to provide a carbon dioxide recovery device which can suppress degradation of sorbent material caused by oxidation, even if isolation of the sorbent material from atmospheric air is released during emergency.

### BRIEF DESCRIPTION OF THE DRAWINGS

FIG. 1 is a schematic diagram showing a configuration related to a flow of gas in a carbon dioxide recovery device according to an embodiment of the present invention;

FIG. 2 is a schematic diagram showing a configuration of a module in the carbon dioxide recovery device according to the present embodiment;

FIG. 3 is a flowchart showing a flow of processing of emergency control of the carbon dioxide recovery device according to the present embodiment; and

FIG. 4 is a schematic diagram showing a configuration related to a flow of gas in the carbon dioxide recovery device according to a modified example.

### DETAILED DESCRIPTION OF THE INVENTION

Hereinafter, embodiments of the present invention will be described while referencing the drawings.

### Overall Configuration

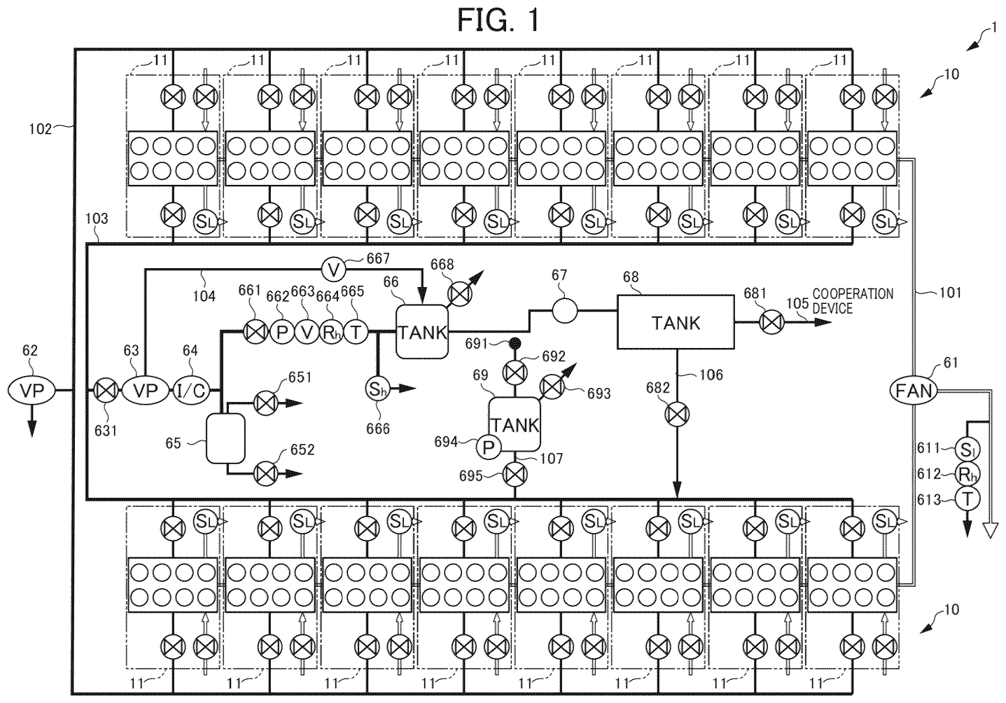

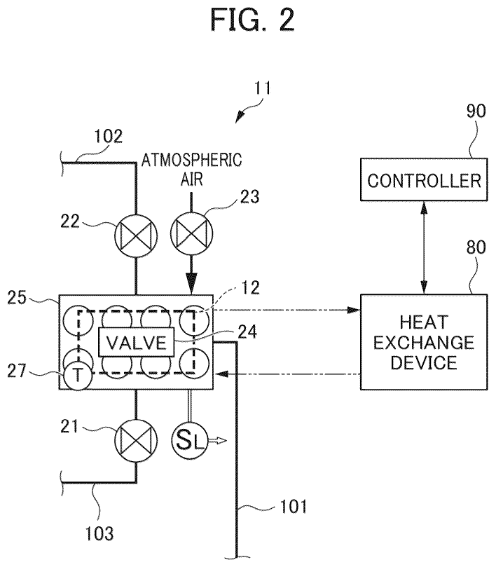

FIG. 1 is a schematic diagram showing a configuration related to a flow of gas in the carbon dioxide recovery device 1 according to an embodiment of the present invention. FIG. 2 is a schematic diagram showing a configuration related to a flow of gas in a module 11 of the carbon dioxide recovery device 1 according to the present embodiment.

The carbon dioxide recovery device 1 of the present embodiment, for example, is applied to direct air recovery technology (DAC: Direct Air Capture) which recovers the carbon dioxide in the atmosphere, in order to decrease the carbon dioxide concentration in the atmosphere. The carbon dioxide recovered by the carbon dioxide recovery device 1 is stored in the ground, and is reused as a fuel or raw material.

As shown in FIGS. 1 and 2, the carbon dioxide recovery device 1 according to the present embodiment includes: a module unit 10, a fan 61, a vacuum pump 62, a carbon dioxide recovery pump 63, an intercooler 64, a separator 65, a first carbon dioxide tank 66, a compressor 67, a second carbon dioxide tank 68, an inert gas tank 69, a heat exchange device 80 (not shown in FIG. 1), and a controller 90 (not shown in FIG. 1).

In addition, the carbon dioxide recovery device 1 includes, as a gas flow path, an adsorption line 101, a vacuum line 102, a carbon dioxide line 103, a circulation line 104, a cooperation line 105, a merging line 106, and an inert gas supply line 107.

It should be noted that, in the following description, the flow of gas from “intake” to “exhaust”, and the flow of gas from the module 11 to the first carbon dioxide tank 66 or second carbon dioxide tank 68 are defined as flow from upstream to downstream.

The module unit 10 is configured by a plurality of the modules 11 which adsorb carbon dioxide being arranged in a line. In the present embodiment, a total number of sixteen of the modules 11 are arranged by a pair of left and right module units 10.

FIG. 2 is a schematic diagram showing the configuration of the module 11 of the carbon dioxide recovery device 1 according to the present embodiment. The module 11 is a carbon dioxide recovery module including a sorbent material 12, a first valve 21, a second valve 22, a third valve 23, a fourth valve 24, a pressure sensor 25, a carbon dioxide sensor 26, and a temperature sensor 27.

The sorbent material 12 is arranged inside of the module 11 in order to adsorb carbon dioxide. The sorbent material 12 is a member in particle form, and has a property of adsorbing carbon dioxide in a low-temperature state (for example, range of −30° C. to 50° C.), and desorbing (releasing) carbon dioxide in a state of high temperature (for example, range of 50° C. to 110° C.) and low concentration of carbon dioxide in the surroundings. As such a sorbent material 12, for example, a carbon dioxide sorbent material of a solid amine configured by supporting an amine on a porous material such as silica, or the like can be exemplified.

The first valve 21 is a switching value arranged at a connection of the module 11 with a carbon dioxide line 103 recovering the carbon dioxide. A carbon dioxide recovery pump 63 is arranged in the carbon dioxide line 103. The second valve 22 is a switching valve arranged at a connection of the module 11 with the vacuum line 102 in which the vacuum pump 62 is arranged. The third valve 23 is a switching valve arranged at an inlet which suctions atmospheric air, etc. into the module 11. The fourth valve 24 is a switching valve arranged at a connection of the module 11 with an adsorption line 101.

The first valve 21, the second valve 22, the third valve 23 and the fourth valve 24 are all controlled to open and close by the controller 90. The first valve 21, the second valve 22, the third valve 23 and the fourth valve 24, for example, are configured by butterfly valves which are normal open.

The pressure sensor 25 measures the internal pressure of the module 11. The carbon dioxide sensor 26 measures the carbon dioxide concentration inside of the module 11. The temperature sensor 27 measures the temperature of the sorbent material 12. The measurement information of the pressure sensor 25, the carbon dioxide sensor 26 and the temperature sensor 27 is sent to the controller 90.

Referring back to FIG. 1, the adsorption line 101 and the fan 61 will be described. The adsorption line 101 is branched to connect to each of the respective modules 11. The fan 61 is arranged at portion of the adsorption line 101 at which the branching portions merge together. The fan 61 produces flow of gas from “intake” to “exhaust” relative to the module 11 through the adsorption line 101 by being driven. The atmospheric air is thereby supplied into the module 11. A carbon dioxide concentration sensor 611, a moisture sensor 612 and a temperature sensor 613 are arranged at a portion of the adsorption line 101 exhausting the gas, and the carbon dioxide concentration exhausted from the adsorption line 101, moisture and temperature are measured. The measurement information of the carbon dioxide concentration sensor 611, the moisture sensor 612 and the temperature sensor 613 is sent to the controller 90.

The vacuum line 102 is branched to connect to each of the respective modules 11. The vacuum pump 62 is arranged at a portion of the vacuum line 102 at which the branching portions merge together. The vacuum pump 62 aspirates gas inside of the module 11 through the vacuum line 102 by way of being driven to make the inside of the module 11 a vacuum state or bring it close to a vacuum state.

The carbon dioxide line 103 is branched to connect to each of the respective modules 11. The carbon dioxide recovery pump 63, the intercooler 64, the separator 65, the first carbon dioxide tank 66, the compressor 67 and the second carbon dioxide tank 68 are arranged at a portion of the carbon dioxide line 103 at which the branching portions merge together.

The carbon dioxide recovery pump 63 applies a suction force to feed the carbon dioxide flowing through the carbon dioxide line 103 to the first carbon dioxide tank 66. A one-way valve 631 is arranged on an upstream side of the carbon dioxide recovery pump 63 in the carbon dioxide line 103. A configuration is thereby made by which gas does not flow back from the intercooler 64 side to the module 11 side.

The intercooler 64 is an intermediate cooler which cools high-temperature gas containing carbon dioxide which was recovered from the module 11, and separates into gas and liquid.

The water produced by gas-liquid separation in the intercooler 64 is recovered in the separator 65. In addition, a first valve 651 and a second valve 652 are arranged at the separator 65, and the first valve 651 opens and closes the passage which communicates a gas-phase part of the separator 65 with atmospheric air. The second valve 652 opens and closes a path which communicates atmospheric air with a liquid-phase part of the separator 65.

The first carbon dioxide tank 66 stores the carbon dioxide recovered through the carbon dioxide line 103. A tank valve 661 is arranged on an upstream side of the first carbon dioxide tank 66 in the carbon dioxide line 103. The tank valve 661 is controlled to open and close by the controller 90. In addition, between the tank valve 661 and the first carbon dioxide tank 66 in the carbon dioxide line 103, various sensors such as a pressure sensor 662, a flowrate sensor 663, a moisture sensor 664, a temperature sensor 665 and a carbon dioxide concentration sensor 666 are arranged.

In addition to the carbon dioxide line 103, the circulation line 104 which returns ballast to the carbon dioxide recovery pump 63 is connected to the first carbon dioxide tank 66. A flowrate sensor 667 is arranged in the circulation line 104. In addition, a pressure relief valve 668 which relieves pressure when becoming a pressure equal to or greater than a predetermined pressure, is arranged in the first carbon dioxide tank 66.

The compressor 67 is arranged between the first carbon dioxide tank 66 and the second carbon dioxide tank 68 in the carbon dioxide line 103. The compressor 67 compresses the carbon dioxide stored in the first carbon dioxide tank 66, and feeds to the second carbon dioxide tank 68.

The second carbon dioxide tank 68 stores the carbon dioxide compressed by the compressor 67 at a fixed pressure or more (for example, 980 kPa). In addition to the carbon dioxide line 103, the cooperation line 105 connected to a cooperation device is connected to the second carbon dioxide tank 68, and the merging line 106 which merges with the carbon dioxide line 103 is connected to the second carbon dioxide tank 68. The cooperation device, for example, is algae cultivation equipment, fuel synthesis equipment, underground storage equipment, or the like. A cooperation valve 681 is arranged in the cooperation line 105, and a merging valve 682 is arranged in the merging line 106. The cooperation valve 681 and the merging valve 682 are controlled to open and close by the controller 90.

Next, the inert gas tank 69 will be described. The inert gas tank 69 stores N₂ as an inert gas supplied from the N₂ gas bottle 691 at a fixed pressure or more (for example, 980 kPa). Between the inert gas tank 69 and the N₂ gas bottle 691, a gas bottle valve 692 is arranged. In addition, a pressure relief valve 693 which relieves pressure when the pressure becomes a predetermined pressure or more is arranged in the inert gas tank 69. A pressure sensor 694 is arranged inside of the inert gas tank 69. The pressure information measured by the pressure sensor 694 is sent to the controller 90.

The inert gas tank 69 is connected to the carbon dioxide line 103 via the inert gas supply line 107. An inert gas valve 695 is arranged in the inert gas supply line 107. The inert gas valve 695 is controlled to open and close by the controller 90.

The heat exchange device 80, upon each module 11 of the module unit 10 performing the desorption process, supplies thermal energy for heating inside of this module 11 up to a predetermined temperature. In addition, the heat exchange device 80 recovers thermal energy which is unwanted upon each module 11 performing adsorption. The heat exchange device 80 is configured by pipes, a heat pump, etc. connected to each module 11, for example. The pipe is a flow path in which the heat transfer medium flows. The heat exchange device 80 supplies thermal energy to each module 11, and recovers the unwanted thermal energy, by way of the heat transfer medium passing through this pipe.

The controller 90 controls the operation of each part of the carbon dioxide recovery device 1. The controller 90 controls operations such as driving and stopping of devices used in the adsorption and desorption of carbon dioxide. The controller 90 performs switching control of the first valve 21, the second valve 22, the third valve 23 and the fourth valve 24 provided to each module 11, and switching control of the separator first valve 651, separator second valve 652, tank valve 661, merging valve 682, and inert gas valve 695. In addition, the controller 90 performs driving control of the fan 61, the vacuum pump 62, the carbon dioxide recovery pump 63, the compressor 67, etc.

The controller 90, for example, is a computer that has a CPU (Central Processing Unit), ROM (Read Only Memory), RAM (Random Access Memory), etc. The controller 90 may be configured as one unit, or may be configured by several units.

### Recovery of Carbon Dioxide

Next, control for recovering carbon dioxide by the controller 90 will be described. The carbon dioxide recovery device 1 removes and recovers carbon dioxide from the air by alternately performing an adsorption process of adsorbing carbon dioxide in a gas aspirated such as atmospheric air to the sorbent material 12 in the module 11, and a desorption process of desorbing the carbon dioxide adsorbed to the sorbent material 12, and then compresses the desorbed carbon dioxide and stores in the first carbon dioxide tank 66 and the second carbon dioxide tank 68.

The adsorption process is a process of adsorbing carbon dioxide to the sorbent material 12 inside the module 11. In the adsorption process, the first valve 21, the third valve 23 and the fourth valve 24 of the module 11 are opened, and the second valve 22 is closed. The fan 61 is driven, whereby a flow of gas from upstream to downstream is generated, and the gas containing carbon dioxide (for example, atmospheric air) is aspirated through the third valve 23. The aspirated gas passes through the sorbent material 12 inside the module 11. At this time, the inside of the module 11 is room temperature (25° C.), and the carbon dioxide in the gas is adsorbed to the sorbent material 12. Gas other than carbon dioxide, for example, nitrogen, oxygen, etc., are exhausted to outside of the carbon dioxide recovery device 1 through the fourth valve 24 and the adsorption line 101.

The desorption process is a process of desorbing the carbon dioxide on the sorbent material 12 within the module 11. In the desorption process, the first valve 21, the third valve 23 and the fourth valve 24 of the module 11 are closed, and the second valve 22 is opened. The vacuum pump 62 runs to aspirate inside of the module 11, and reduces the pressure to a vacuum state or brings it close to a vacuum state. Simultaneously, the heat transfer medium serving as a heat source flows with the module 11 to supply thermal energy by way of the heat exchange device 80, thereby heating the module 11. The sorbent material 12 is also heated to a predetermined temperature (for example, 90° C.) sufficient for the desorption process, whereby the carbon dioxide adsorbed to the sorbent material 12 is desorbed. The second valve 22, the third valve 23 and the fourth valve 24 are closed, the first valve 21 is opened, and the carbon dioxide recovery pump 63 is driven, whereby the desorbed carbon dioxide passing through the carbon dioxide line 103 is stored in the first carbon dioxide tank 66 and the second carbon dioxide tank 68.

In the present embodiment, the controller 90 controls the respective modules 11 so as to cause the adsorption process to be executed in twelve modules among the sixteen modules 11, and four modules 11 execute the desorption process. For this reason, during operation of the carbon dioxide recovery device 1, the four modules 11 performing the desorption process enter a high-temperature state.

### Emergency Control

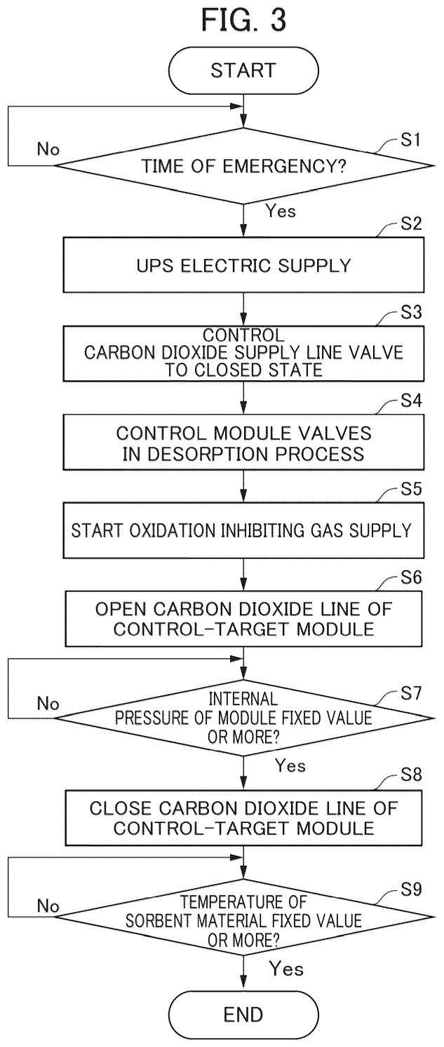

Next, emergency control for performing oxidation prevention of the sorbent material 12 during an emergency such as power outage or failure will be described. Emergency control will be described by referencing FIG. 3. FIG. 3 is a flowchart showing the flow of processing of emergency control in the carbon dioxide recovery device 1 according to the present embodiment.

It should be noted that, as a premise for emergency control, it is assumed that, during normal running, the inside of the module 11 execution in normal running becomes negative pressure by the reduced pressurization of the vacuum pump 62, and the temperature of the sorbent material 12 becomes a high temperature of a fixed value or higher by the heat exchange device 80. In addition, during normal running, the first valve 21, the tank valve 661, the separator first valve 651 and the separator second valve 652 are controlled to the open state or closed state according to the running state. The inert gas valve 695 is controlled to the closed state, and the internal pressure of the inert gas tank 69 is maintained at a fixed value or more.

In Step S1, the controller 90 determines whether an operation signal indicating a time of emergency has been received. The operation signal indicating a time of emergency may be a signal indicating power outage such as blackout, may be a signal indicating failure, or may be a signal designating emergency control by the operator. The controller 90 continues monitoring until receiving an operation signal indicating a time of emergency (Step 1: No). The controller 90 advances the processing to Step S2 when receiving an operation signal indicating a time of emergency (Step S1: Yes).

In Step S2, electric supply from an uninterruptible power supply (UPS) is performed to each configuration of the carbon dioxide recovery device 1. The emergency control on a control system by the controller 90 is thereby started.

In Step S3, the controller 90 controls all of the tank valve 661, the separator first valve 651 and the separator second valve 652 to the closed state. The upstream side of the first carbon dioxide tank 66 in the carbon dioxide line 103 is closed.

In Step S4, the controller 90 executes control on each valve of the module 11 which is the control target having performed the desorption process. In the present embodiment, the controller 90 maintains the closed state of the fourth valve 24 in the adsorption line 101, and controls the second valve 22 in the vacuum line 102 and the third valve 23 communicating with atmospheric air to the closed state.

In Step S5, the controller 90 performs controls to start the supply of oxidation inhibiting gas. In the present embodiment, the inert gas valve 695 of the inert gas supply line 107 is controlled to the open state. The inert gas tank 69 and the carbon dioxide line 103 are thereby in communication.

In Step S6, the controller 90 controls the first valve 21 in the carbon dioxide line 103 of the module 11 which is the control target to the open state, thereby opening the carbon dioxide line 103. Since inside of the inert gas tank 69 is maintained at a fixed pressure or more, N₂ as the inert gas flows in through the inert gas supply line 107 and the carbon dioxide line 103 to inside of the module 11 in a vacuum state or nearly a vacuum state.

In Step S7, the controller 90 references the measurement information of the pressure sensor 25 of the module 11 which is the control target, and determines whether the internal pressure of the module 11 is a predetermined value or more. The controller 90 continues monitoring until the internal pressure of the module 11 becomes a predetermined value or more (Step S7: No). The controller 90 advances the processing to Step S8 when the internal pressure of the module 11 is a predetermined value or more (Step S7: Yes).

In Step S8, the controller 90 controls the first valve 21 in the carbon dioxide line 103 of the module 11 which is the control target to the closed state, thereby closing the carbon dioxide line 103. Since the internal pressure of the module 11 is a predetermined value or more, the air pressure difference from atmospheric pressure also becomes small. Even if the fourth valve 24 opens and the inside of the module 11 is opened to atmospheric air, it is possible to avoid a situation where the respective configurations of the module 11 are damaged due to pressure changes.

In Step S9, the controller 90 references the measurement information of the temperature sensor 27 of the module 11, and determines whether the temperature of the sorbent material 12 in the module 11 is a fixed temperature or less. The controller 90 continues monitoring while maintaining aforementioned respective controls until the temperature becomes a fixed temperature or less (Step S9: No). The controller 90 ends this processing flow when the temperature becomes a fixed temperature or less (Step S9: Yes).

Referencing FIG. 3, the configuration which supplies inert gas of N₂ as the oxidation inhibiting gas to the module 11 in the desorption process will be described; however, in the case of a sufficient carbon dioxide amount being stored in the second carbon dioxide tank 68, the stored carbon dioxide may be supplied to the module 11 in the desorption process as oxidation inhibiting gas. In this case, in Step S5, the controller 90 controls the cooperation valve 681 to the closed state, and controls the merging valve 682 to the open state to bring the second carbon dioxide tank 68 and the carbon dioxide line 103 into communication. Then, in Step S6, the controller 90 controls the first valve 21 in the carbon dioxide line 103 to the open state. Since the inside of the second carbon dioxide tank 68 is retained at a fixed pressure or more, carbon dioxide as an oxidation inhibiting gas flows through the merging line and the carbon dioxide line 103 to inside of the module 11 which is in a vacuum state or nearly a vacuum state. It should be noted that control other than this is similarly to the case of supplying the inert gas of N₂ as the oxidation inhibiting gas to the module 11 which is in the desorption process.

In addition, the controller 90 may be established as a configuration that switches the type of oxidation inhibiting gas according to the stored amount of N₂ in the inert gas tank 69 or the stored amount of carbon dioxide in the second carbon dioxide tank 68. For example, the controller 90 may be established as a configuration that supplies inert gas of the inert gas tank 69 to the module 11 as oxidation inhibiting gas in the case of the stored amount of carbon dioxide in the second carbon dioxide tank 68 being scarce at the beginning of operation start, and supplies carbon dioxide of the second carbon dioxide tank 68 as oxidation inhibiting gas to the module 11 when the stored amount of inert gas in the inert gas tank 69 becomes scarce.

As described above, the carbon dioxide recovery device 1 according to the present embodiment includes: the module 11 that includes the sorbent material 12 inside thereof, and executes the adsorption process of aspirating a gas containing carbon dioxide and adsorbing the carbon dioxide to the sorbent material 12; and the desorption process of desorbing the carbon dioxide from the sorbent material 12 by heating in a state where a periphery of the sorbent material 12 is reduced pressure; the first carbon dioxide tank 66 that stores the carbon dioxide recovered from the module 11 in the course of the adsorption process and the desorption process; the oxidation inhibiting gas tank (second carbon dioxide tank 68, inert gas tank 69) that stores an oxidation inhibiting gas that prevents oxidation of the sorbent material 12; and the controller 90 that supplies the oxidation inhibiting gas from the oxidation inhibiting gas tank to the module 11 during execution of the desorption process, when an emergency situation is detected.

During an emergency such as power outage or failure, since the oxidation inhibiting gas such as an inert gas or carbon dioxide is supplied to the module 11 executing the desorption process, the periphery of the sorbent material 12 inside of the module 11 is thereby filled with oxidation inhibiting gas. Therefore, even if the fourth valve 24 connecting with atmospheric air entered the open state due to power outer, failure or the like, atmospheric air will not enter to the inside of the module 11, and thus it is possible to avoid the occurrence of a situation where the sorbent material 12 in a high-temperature state degrades when exposed to atmospheric air.

In addition, in the present embodiment, the oxidation inhibiting gas tank is the inert gas tank 69 that stores the inert gas as the oxidation inhibiting gas. It is thereby possible to prevent oxidation of the sorbent material 12 by an inert gas such as N₂ gas. In the case of utilizing the recovered carbon dioxide as the oxidation inhibiting gas, even without the stored amount of carbon dioxide being sufficient, it is possible to more reliably prevent oxidation of the sorbent material 12 by the separately prepared inert gas.

In addition, in the present embodiment, the oxidation inhibiting gas tank is the second carbon dioxide tank 68 that stores the carbon dioxide recovered from the module 11 as the oxidation inhibiting gas. Since the recovered carbon dioxide can be used, the configuration for supplying oxidation inhibiting gas during emergency can be realized at low cost.

In addition, in the present embodiment, the second carbon dioxide tank 68 and the inert gas tank 69 store the oxidation inhibiting gas at a fixed pressure or more. The oxidation inhibiting gas is thereby supplied by the pressure differential by simply the path being connected to the module 11 which is in a vacuum state or nearly a vacuum state. Since a drive device such as the carbon dioxide recovery pump does not need to be utilized, it is possible to curb the power usage during emergency.

In addition, with the present embodiment, the controller 90 stops the supply of the oxidation inhibiting gas (inert gas, carbon dioxide), when the internal pressure of the module 11 undergoing the supply of oxidation inhibiting gas is a fixed value or more. By the inside of the module 11 communicating with atmospheric air in a vacuum state or a state which is nearly a vacuum state, it is thereby possible to avoid the occurrence of a situation where the configuration of the module 11 is damaged by the air pressure difference.

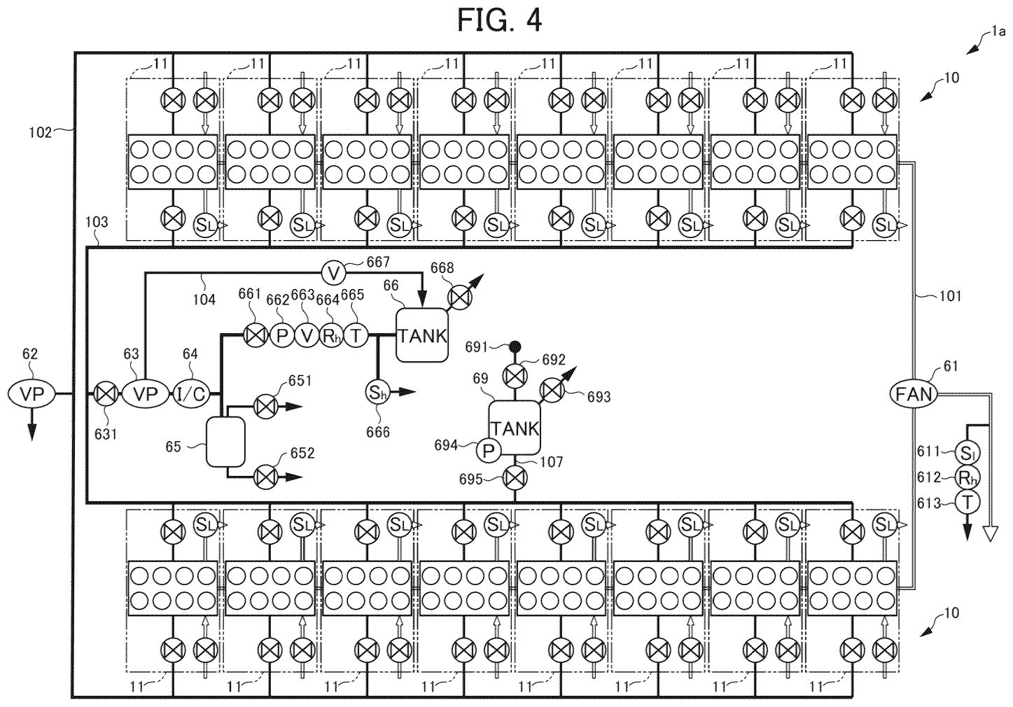

The configuration of the carbon dioxide recovery device 1 is not meant to be limited to the configuration of the above embodiment. FIG. 4 is a schematic diagram showing a configuration related to a flow of gas in a carbon dioxide recovery device la according to a modified example. The carbon dioxide recovery device la according to the modified example is made by omitting the configurations of the second carbon dioxide tank 68, the cooperation line 105, the cooperation valve 681, the merging line 106, the merging valve 682, etc. from the carbon dioxide recovery device 1 of the first embodiment. It should be noted that the other configurations thereof are the same as the above embodiment.

Although embodiments of the present invention have been described above, it is not to be limited to the aforementioned embodiments and modified examples. In addition, the effects described in the above embodiments are merely exemplifying the preferred effects, and the effects thereof are not limited to those described in the above embodiments.

### EXPLANATION OF REFERENCE NUMERALS

1 carbon dioxide recovery device
11 module
12 sorbent material
21 first valve
22 second valve
23 third valve
24 fourth valve
66 first carbon dioxide tank
68 second carbon dioxide tank
69 inert gas tank
695 inert gas valve

What is claimed is:

1. A carbon dioxide recovery device comprising:
a module that includes a sorbent material inside thereof, and executes an adsorption process of aspirating a gas containing carbon dioxide and adsorbing the carbon dioxide to the sorbent material; and a desorption process of desorbing the carbon dioxide from the sorbent material by heating in a state where a periphery of the sorbent material is reduced pressure;
a carbon dioxide tank that stores the carbon dioxide recovered from the module in a course of the adsorption process and the desorption process;
an oxidation inhibiting gas tank that stores an oxidation inhibiting gas that prevents oxidation of the sorbent material; and
a controller that supplies the oxidation inhibiting gas from the oxidation inhibiting gas tank to the module during execution of the desorption process, when an emergency situation is detected.

2. The carbon dioxide recovery device according to claim 1, wherein the oxidation inhibiting gas tank is an inert gas tank that stores an inert gas as the oxidation inhibiting gas.

3. The carbon dioxide recovery device according to claim 1, wherein the oxidation inhibiting gas tank is a second carbon dioxide tank that stores the carbon dioxide recovered from the module as the oxidation inhibiting gas.

4. The carbon dioxide recovery device according to claim 1, wherein the oxidation inhibiting gas tank stores the oxidation inhibiting gas at a fixed pressure or more.

5. The carbon dioxide recovery device according to claim 1, wherein the controller stops supply of the oxidation inhibiting gas, when an internal pressure of the module undergoing supply of the oxidation inhibiting gas becomes a fixed value or more.
